(19) United States
(12) Patent Application Publication
(10) Pub. No.: US 2010/0216930 A1
(43) Pub. Date: Aug. 26, 2010

(54) Optical Resin Material and Optical Element

(75) Inventors: Kazuhito Ihara, Tokyo (JP); Masako Kikuchi, Tokyo (JP)

Correspondence Address: COHEN, PONTANI, LIEBERMAN & PAVANE LLP, 551 FIFTH AVENUE, SUITE 1210, NEW YORK, NY, 10176, US

(73) Assignee: Konica Minolta Opto, Inc., Tokyo (JP)

(21) Appl. No.: 12/738,423

(22) PCT Filed: Oct. 1, 2008
(86) PCT No.: PCT/JP2008/067819

§ 371 Date: Apr. 16, 2010

(30) Foreign Application Priority Data
Oct. 19, 2007 (JP) 2007-272325

(51) Int. Cl. C08K 3/22

(52) U.S. Cl. 524/430

(57) ABSTRACT

An optical resin material, which, while able to form a plastic optical element produceable at low cost, has excellent heat resistance and, at the same time, has excellent optical stability high enough to avoid a change in optical properties even after use for a long period of time, and an optical element using the optical resin material. The optical resin material contains a curable resin and hydrophobic oxide particles and is characterized in that it satisfies an absorbance intensity ratio B/A of not less than 0.01 and not more than 0.25, wherein A represents an absorbance intensity at 1720 cm⁻¹ in an infrared absorption spectrum of the optical resin material after curing; and B represents an absorbance intensity at 1637 cm⁻¹, and the volume average particle diameter of the hydrophobic oxide particles is not less than 1.0 nm and not more than 50 nm.

### FIELD OF THE INVENTION

The present invention relates to an optical resin material and an optical element utilizing the optical resin material, and more specifically relates to an optical resin material which has excellent heat resistance and excellent optical stability, and an optical element utilizing said optical resin material.

### BACKGROUND OF THE INVENTION

Generally, as an optical element to achieve a desired optical function by transmitting light, an optical element employing such as glass or plastic is utilized. An optical element includes such as an optical lens and a compensation element utilized in various optical instruments. For example, such as an imaging optical system utilized in imaging devices, for example, a silver salt photographic camera, a digital camera and a medical imaging device; an optical system of an optical pickup device and an optical element utilized in an optical communication module are listed.

Specifically, since an optical element employing plastic can be molded by such as injection molding and extrusion molding, and can be molded at relatively low temperature as well as can be manufactured at a cost lower than an optical element employing glass, an optical element employing plastic which can replace an optical element employing glass has been strongly desired.

Heretofore, as an optical element utilized in an optical system of an optical imaging system or an optical pickup device, an optical element utilizing thermoplastic resin has been widely known. For example, a copolymer of cyclic olefin and α-olefin has been proposed as thermoplastic resin applicable to an optical element of an optical pickup device (for example, refer to Patent Document 1).

However, since an optical element utilizing a thermoplastic resin has lower heat resistance compared to an optical element employing glass and may cause variation of optical properties when being exposed to a high temperature environment, there has been a problem in utilizing the element as an optical element of an imaging optical system or as an optical element of an optical pickup device, which requires high optical precision. Further, an imaging optical system may have an occasion to be exposed to various environments depending on the imaging condition, and in addition, an optical pickup device may be exposed to a high temperature due to the heat generated by the operation of a device for tracking or focusing.

In order to avoid such a problem, a resin composition containing a thermoplastic resin and an oxide compound having a hydrophobic group and a polar group on the surface is disclosed in Japanese Patent Application Publication (hereinafter, referred to as JP-A) No. 2004-269773, of which purpose is to improve rigidity and dimensional stability. In such a resin composition, since crystalline micro-particles or amorphous silica particles such as colloidal silica are used in the manufacturing process to improve the mechanical strength and the stiffness of the resin composition by forming a steric structure via a cross-linking reaction between the particles and the host resin, the molding property of such a resin composition is not fully enough due to the lower fluidity. Only not fully sufficient light transmittance for application as an optical element can be attained by a resin composition prepared by these methods since the fluidity is greatly decreased as well as the transparency easily lowered, when the volume ratio of micro-particles is increased.

On the other hand, as an example of an optical element employing a plastic, there is cited a composition containing silica particles being subjected to a hydrophobic treatment employing silane coupling agent, and a curable resin as an optical material (for example, refer to Patent Document 2). However, the method disclosed in Patent Document 2 cannot fully suppress linear expansion although the control of transparency is possible.

Patent Document 1: JP-A No. 2002-105131

Patent Document 2: JP-A No. 2005-213453 (page 2)

### DISCLOSURE OF THE INVENTION

### Problems to be Solved by the Invention

As a curable resin, for example, such as a thermally curable resin and an actinic ray curable resin as described above have been known. However, it has been proved that a curable resin cannot finish complete curing even when it is sufficiently cured to the hardness required as an optical element at the time of molding of the optical element, and curing proceeds by influence of such as heat and ultraviolet rays to cause variation of optical properties due to such as curing shrinkage. It has been proved that such a small variation of optical properties is not a problem in the case of an ordinary optical element such as an eye glass lens; however, it may become a problem in the case of an optical element in which highly precious optical properties are required.

The present invention has been made in view of the above described problems, and an object of the present invention is to provide an optical element exhibiting excellent heat resistance, transparency and optical stability, while being a plastic optical element which can be produced at a low cost, and an optical resin material constituting said optical element.

### Means to Solve the Problems

The above-described object of the present invention can be achieved by the following structures.

1. An optical resin material comprising a curable resin and hydrophobic oxide particles, wherein

an absorbance intensity ratio B/A is 0.01 to 0.25, provided that A represents an absorbance intensity at 1720 cm⁻¹ of an infrared absorption spectrum of the optical resin material after cured, and B represents an absorbance intensity at 1637 cm⁻¹ of the infrared absorption spectrum of the optical resin material after cured; and

a volume average particle diameter of the hydrophobic oxide particles is 1.0 nm to 50 nm.

2. The optical resin material of item 1, wherein the curable resin is a thermally curable resin.

3. The optical resin material of item 1 or 2, wherein the curable resin comprises an acryl monomer.

4. The optical resin material of any one of items 1-3, wherein surfaces of the hydrophobic oxide particles are subjected to a hydrophobic treatment with a silazane.

5. The optical resin material of any one of items 1-3, wherein surfaces of the hydrophobic oxide particles are subjected to a hydrophobic treatment with a silane coupling agent having a reactive group.

6. The optical resin material of any one of aforesaid items 1-3, wherein surfaces of the hydrophobic oxide particles are subjected to a hydrophobic treatment with a chlorosilane.

7. An optical element molded by employing the optical resin material of any one of items 1-6.

### Effect of the Invention

According to the present invention, an optical element which has excellent heat resistance and excellent optical stability high enough to avoid variation of optical properties even after use for a long period of time, while able to form a plastic optical element produceable at low cost, and an optical resin material constituting said optical element could be provided.

### DESCRIPTION OF THE PREFERRED EMBODIMENTS

In the following, the most preferable embodiments to practice the present invention will be detailed.

An optical resin material of the present invention is characterized in that absorbance intensity ratio B/A is not less than 0.01 and not more than 0.25, wherein A represents an absorbance intensity at 1720 cm⁻¹ in an infrared absorption spectrum of the optical resin material after curing; and B represents an absorbance intensity at 1637 cm⁻¹.

In the present invention, as for the absorbance intensity in an infrared absorption spectrum according to the present invention, an optical composite resin material was measured by use of Fourier Transformation Infrared Spectrometer NICOLET 380 (manufactured by Thermo Fisher Scientific Inc.).

Absorbance intensity A: an absorbance intensity at 1720 cm⁻¹, is a peak assigned to R—COO—R; and absorbance intensity B: an absorbance intensity at 1637 cm⁻¹, is a peak assigned to the unsaturated bond of C═C. When the value of absorbance intensity ratio B/A is not more than 0.25, an optical element which is not suffered from curing due to ultraviolet rays and heat after the optical element is cured and from variation of optical properties even after long time use, and is applicable to an optical element to which high precision is required, can be obtained.

Absorbance intensity ratio B/A is preferably not more than 0.25, more preferably not more than 0.20 and furthermore preferably not more than 0.10.

High heat resistance can be achieved by dispersing hydrophobic oxide particles in a curable resin, and, at the same time, by heating in a post-curing process, it is possible to suppress progress of curing due to ultraviolet rays and heat after the optical element is cured and no variation of optical properties due to aging is observed, whereby an optical element applicable even when high precision is required can be obtained.

The heating time in a post-curing process is preferably not shorter than 2 hours and the heating temperature is not lower than the temperature of Tg of the resin −20° C., more preferably not lower than the temperature of Tg of the resin and specifically preferably not lower than the temperature of Tg of resin +20° C.

Further, by providing a reactive group in the surface treating agent utilized for a hydrophobic treatment of hydrophobic oxide particles, it is also possible to suppress progress of curing due to ultraviolet rays and heat after the optical element is cured, and no variation of optical properties due to aging is observed, whereby an optical element applicable even when high precision is required can be obtained.

(1) Curable Resin

A curable resin applicable in the present invention may be either an actinic ray curable resin which cures by irradiation of such as ultraviolet rays or electron rays or a thermally curable resin which cures by a heat treatment. As said curable resin, various curable resins listed in the following can be preferably utilized.

Specifically, the curable resin according to the present invention is preferably a thermally curable resin, and further, it is preferable that the curable resin is constituted of an acrylic monomer.

(1.1) Silicone Resin

A silicone resin having a siloxane bond containing Si—O—Si as the primary chain can be utilized. As said silicone resin, a silicone resin containing a predetermined amount of a polyorganosiloxane resin can be utilized (for example, refer to JP-A No. 6-9937).

The thermally curable polyorganosiloxane resin is not specifically limited as far as the polyorganosiloxane resin has a three-dimensional network due to a siloxane bond moiety formed by a continuous hydrolysis-dehydration condensation reaction caused by heating. The polyorganosiloxane resin generally exhibits a curing property when a high temperature is applied for a long time by heating and has a property that it is hardly softened by further heating when once cured.

Such a polyorganosiloxane resin contains a structural unit represented by following Formula (A) and the form may be any of a chain form, a cyclic form and a network form.

((R₁)(R₂)SiO)ₙ Formula (A)

In above described Formula (A), R₁ and R₂ each represent a substituted or unsubstituted mono-valent hydrocarbon group which may be the same with or different from each other. Specifically, examples of R₁ and R₂ include: alkyl groups such as a methyl group, an ethyl group, a propyl group and a butyl group; alkenyl groups such as a vinyl group and an allyl group; aryl groups such as a phenyl group and a tolyl group; cycloalkyl groups such as a cyclohexyl group and a cyclooctyl group; and groups obtained by replacing a hydrogen atom bonded to a carbon atom of the above groups with, for example, a halogen atom, a cyano group or an amino group, such as a chloromethyl group, a 3,3,3-trifluoropropyl group, a cyanomethyl group, a γ-aminopropyl group, a N-(β-aminoethyl)-γ-aminopropyl group. R₁ and R₂ each may also be a group selected from a hydroxyl group and an alkoxy group. Further, n in above-described Formula (A) is an integer of not smaller than 50.

A polyorganosiloxane resin is generally utilized by being dissolved in a hydrocarbon type solvent such as toluene, xylene and a petroleum type solvent or in a mixed solvent thereof with a polar solvent. Further, these solvents may also be utilized by blending with a solvent having a different composition, as far as those solvents are miscible with each other.

A manufacturing method of polyorganosiloxane is not specifically limited and any method well known in the art can be employed. For example, polyorganosiloxane resin can be prepared by hydrolysis or alcholysis of one type or not less than two types of organohalogenosilane, and generally contains hydrolyzing groups such as a silanol group or an alkoxy group, the content of which is 1-10 weight % based on converted silanol group content.

These reactions are generally conducted in the presence of a solvent which is capable of dissolving organohalogenosilane. Further, polyorganosiloxane resin can be also prepared by a method for synthesis of block copolymer, in which conducted is cohydrolysis of straight chain type polyorganosiloxane having a hydroxyl group, an alkoxy group or a halogen atom on the molecular chain end, together with organotrichlorosilane. Polyorganosiloxane resin thus prepared generally contains residual HCl; however, in a composition of this embodiment, it is preferable to utilize those containing HCl of not more than 10 ppm and preferably not more than 1 ppm in view of achieving excellent storage stability.

(1.2) Epoxy Resin

As epoxy resin, for example, alicyclic epoxy resin (for example, refer to PCT International Application Publication No. 2004/031257) such as 3,4-epoxycyclohexylmethyl-3′,4′-cyclohexylcarboxylate can be utilized and, in addition, epoxy resin having a spiro ring and chain aliphatic epoxy resin can be also utilized.

(1.3) Curable Resin Having Adamantane Skeleton

As curable resin having an adamantine skeleton, for example, curable resin having an adamantine skeleton provided with no aromatic rings such as 2-alkyl-2-adamantyl (meth)acrylate (for example, refer to JP-A 2002-193883), 3,3′-dialkoxycarbonyl-1,1′-biadamantane (for example, refer to JP-A 2001-253835), 1,1′-biadamantane compounds (for example, refer to U.S. Pat. No. 3,342,880), tetraadamantane (for example, refer to JP-A 2006-169177), 2-alkyl-2-hydroxyadamantane, 2-alkyleneadamantane and di-tert-butyl 1,3-adamantane dicarboxylate (for example, refer to JP-A 2001-322950); bis(hydroxyphenyl)adamantanes and bis(glycidyloxyphenyl)adamantine (for example, refer to JP-A 11-35522 and JP-A 10-130371) can be utilized.

(1.4) Resin Containing Allylester Compound

As resin containing an allylester compound, for example, such as bromine-containing (meta)allylester without no aromatic rings (for example, refer to JP-A 2003-66201), allyl(meth)acrylate (for example, refer to JP-A 5-286896), allylester resin (for example, refer to JP-A 5-286896 and JP-A 2003-66201), a copolymer of acrylic ester and an unsaturated compound containing an epoxy group (for example, refer to JP-A 2003-147072) and an acrylic ester compound (for example, refer to JP-A 2005-2064) can be preferably utilized.

Further, a hardener of epoxy resin is not specifically limited; however, an acid anhydride hardener and a phenol hardener are exemplified.

Examples of an acid anhydride hardener include such as phthalic anhydride, maleic anhydride, trimellitic anhydride, pyromellitic anhydride, hexahydrophthalic anhydride; 3-methyl-hexahydrophthalic anhydride, 4-methyl-hexahydrophthalic anhydride or a mixture of 3-methyl-hexahydrophthalic anhydride and 4-methyl-hexahydrophthalic anhydride; tetrahydrophthalic anhydride, nadic anhydride and methylnadic anhydride.

Further, a polymerization initiator is preferably a polymerization initiator of acrylic monomer which generates a radical, and an azo type initiator and a peroxide type initiator can be utilized.

An oil-soluble peroxide type or azo type initiator is also preferably utilized and the examples includes peroxide type initiators such as benzoyl peroxide, lauroyl peroxide, octanoyl peroxide, orthochlorobenzoyl peroxide, orthomethoxybenzoyl peroxide, methyl ethyl ketone peroxide, diisopropyl peroxy dicarbonate, cumene hydroperoxide, cyclohexanone peroxide, t-butylhydroperoxide and diisopropylbenzen hydroperoxide; 2,2′-azobisbutyronitrile, 2,2′-azobis(2,4-dimethylvaleronitrile), 2,2′-azobis(2,3-dimethylbutyronitrile), 2,2′-azobis(2-methylbutyronitrile), 2,2′-azobis(2,3,3-trimethylbutyronitrile), 2,2′-azobis(2-isopropylbutyronitrile), 1,1′-azobis(cyclohexane-1-carbonitrile), 2,2′-azobis(4-methoxy-2,4-dimethylvaleronitril), 2-(carbamoylazo)isobutyronitrile, 4,4′-azobis(4-cyanovaleric acid) and dimethyl-2,2′-azobisisobutyrate.

Organic peroxides and such as tertiary isobutyl hydroperoxide, cumen hydroperoxide and paramethane hydroperoxide; and hydrogen peroxide are specifically preferred.

These polymerization initiators are utilized preferably at 0.01-20 weight % and specifically preferably at 0.1-10 weight %, against polymerizing monomer.

Further, a hardening accelerator may be appropriately incorporated. A hardening accelerator is not specifically limited provided having excellent hardening property without coloring and not disturbing transparency of thermally curable resin. For example, imidazoles such as 2-ethyl-4-methylimidazole (2E4MZ, manufactured by Shikoku Chemicals Corp.), tertiary amine, quaternary ammonium salt, bicyclic amidines such as diazabicycloundecene and derivatives thereat phosphine and phosphonium salt can be utilized; and mixtures of one type or not less than two types thereof may be also utilized.

(2) Hydrophobic Oxide Particles

Hydrophobic oxide particles are micro-particles containing homogeneous oxide particles the surface of which having been subjected to a hydrophobic treatment. Homogeneous oxide particles are particles in which one type of metal oxide is uniformly distributed, and specifically, for example, are oxide particles constituted of any one type of oxide among silica or silicon oxide, titanium oxide, zinc oxide, aluminum oxide, zirconium oxide, hafnium oxide, niobium oxide, tantalum oxide, magnesium oxide, calcium oxide, strontium oxide, barium oxide, yttrium oxide, lanthanum oxide, cerium oxide, indium oxide, tin oxide and lead oxide. Further, homogeneous oxide particles may be composite oxide particles containing silicon oxide and not less than one type of metal oxide other than silicon oxide being uniformly distributed and, for example, may be composite oxide particles constituted of silica or silicon oxide, and not less than one type of oxide among titanium oxide, zinc oxide, aluminum oxide, zirconium oxide, hafnium oxide, niobium oxide, tantalum oxide, magnesium oxide, calcium oxide, strontium oxide, barium oxide, yttrium oxide, lanthanum oxide, cerium oxide, indium oxide, tin oxide and lead oxide, wherein each oxide is uniformly distributed.

Homogeneous oxide particles referred in the present invention are particles in a state that silicon oxide (such as silica) and other metal oxide are uniformly distributed without localization in the particles, and there in no refractive index distribution in said particles.

The form of hydrophobic oxide particles is not specifically limited; however, micro-particles of a spherical form are preferably utilized. Further, the particle diameter distribution is not also specifically limited; however, those having a relatively narrow distribution rather than those having a wider distribution are preferably utilized to effectively reveal the effect of the present invention.

The volume average particle diameter of hydrophobic oxide particles according to the present invention is characterized by being 1-50 nm and preferably 2-30 nm. In the case of applying hydrophobic oxide particles having a volume average particle diameter of not more than 1 nm, it is not preferable because of difficulty to uniformly dispersing said hydrophobic oxide particles in thermally curable resin, while in the case of applying hydrophobic oxide particles having a volume average particle diameter of over 50 nm, it is not preferable because of causing decrease of light transmittance of an optical resin material (or an optical element constituted thereof).

Herein, hydrophobic oxide particles also include those containing the above-described oxide particles on the surface of which a silica layer is formed and the surface of said silica layer has been subjected to a hydrophobic treatment

(2.1) Particle Forming Process

A preparation method of homogeneous oxide particles includes such as a thermal decomposition method (a method to prepare micro-particles by thermal decomposition of stating materials, such as a spray dry method, a flame spray method, a plasma method, a gas phase reaction method, a freeze dry method, a heating kerosene method and a heating petroleum method), a precipitation method (a co-precipitation method), a hydrolysis method (such as an aqueous salt solution method, an alkoxide method and a sol-gel method), a hydrothermal method (such as a precipitation method, a crystallization method, a hydrothermal decomposition method and a hydrothermal oxidation method). Among them, a thermal decomposition method, a precipitation method and a hydrolysis method are preferable with respect to preparing oxide particles having small particle diameter and uniformity. At the time of preparation of said homogeneous oxide particles, these methods may be utilized in combination.

(2.2) Hydrophobic Treatment Process

In hydrophobic oxide particles according to the present invention, the surface is preferably subjected to a hydrophobic treatment with silazanes, a silane coupling agent having a reactive group or a chlorosilane agent.

A method of a hydrophobic treatment for the surface of homogeneous oxide particles includes such as a surface treatment by a surface modifier such as a coupling agent and a surface treatment by means of polymer graft or mechanochemical.

A surface modifier utilized in a hydrophobic treatment against the surface of homogeneous oxide particles includes coupling agents of such as a silane type, a silicone oil type, a titanate type, a alminate type and a siliconate type coupling agent. These are not specifically limited and can be appropriately selected according to types of homogeneous oxide particles and thermally curable resin. Further, not less than two of various surface treatments may be performed at the same time or at different times.

Specifically, as a surface treatment agent of a silane type, such as silazanes: vinyl silazane, hexamethyldisilazane and tetramethyldisilazane; chlorosilanes: trimethylehlorosilane, dimethyldichlorosilane, methyltrichlorosilane and vinyltrichlorosilane; alkoxysilanes: trimethylalkoxysilane, dimethyldialkoxysilane and methyltrialkoxysilane; and silane coupling agents: vinyltriacetoxysilane, vinyltris(methoxyethoxy) silane, vinyltrimethoxysilane, vinyltriethoxysilane and allyltrimethoxysilane; are applicable; and such as trimethylmethoxysilane, dimethyldimethoxysilane, methyltrimethoxysilane and hexamethyldisilazane are preferred.

As a surface treating agent of a silicone oil type, for example, a straight silicon oil such as dimethylsilicone oil, methylphenyl silicone oil and methylhydrogen silicone oil; and modified silicone oil such as amino modified silicone oil, epoxy modified silicone oil, carboxyl modified silicone oil, carbinol modified silicone oil, methacryl modified silicone oil, mercapto modified silicone oil, phenol modified silicone oil, one end reactive modified silicone oil, different functional group modified silicone oil, polyether modified silicone oil, methylstyryl modified silicone oil, alkyl modified silicone oil, higher fatty acid ester modified silicone oil, hydrophilic specific modified silicone oil, higher alchoxy modified silicone oil, higher fatty acid containing modified silicone oil and fluorine modified silicone oil can be utilized.

As a surface treatment agent, a surface treatment agent of a silane type is preferable and specifically preferable are silazanes, chlororsilanes and a silane coupling agent.

Further, these surface treatment agents may be appropriately diluted by such as hexane, toluene, methanol, ethanol or acetone.

A hydrophobic treatment by the above-described surface modifier includes such as a wet heating method, a wet filtering method, a dry stirring method, an integral blend method and a granulating method. In the case of applying a hydrophobic treatment against the surface of homogeneous oxide particles having a volume average particle diameter of not more than 100 nm, either a dry stirring method or a wet stirring method can be employed with respect to restraining coagulation of particles.

Either one type or plural types of these surface modifiers may be utilized, and further, since properties of homogeneous oxide particles (hydrophobic oxide particles) after a hydrophobic treatment may differ depending on a surface modifier utilized, it is also possible to strengthen the affinity with thermally curable resin utilized for preparation of an optical resin material by selection of the surface modifier. The ratio of a surface modifier is not specifically limited; however, the ratio of a surface modifier against homogeneous oxide particles (hydrophobic oxide particles) after a hydrophobic treatment is preferably 10-99 weight % and more preferably 30-98 weight %.

Herein, between the above-described particle funning process and hydrophobic treatment process, the surface of homogeneous oxide particles prepared after the particle forming process may be provided with a composite oxide surface modification treatment to form a silica layer containing tetramethoxysilane or tetraethoxysilane on the surface of said homogeneous oxide particles (a silica layer forming process) and the above-described hydrophobic treatment may be applied on the surface of said silica layer.

(23) Additives

At the time of preparation of an optical resin material (including processes from the above-described particle forming process to kneading process) or at the time of preparation of an optical element (including the above-described molding process), in the present invention, various additives may be appropriately incorporated. Said additives include stabilizers such as an antioxidant, a light fastness stabilizer, a thermal stabilizer, a weather proofing agent, a ultraviolet ray absorbing agent and an infrared ray absorbing agent; resin modifiers such as a sliding agent and a plasticizer, anti-whitening agents such as a soft polymer and an alcoholic compound; coloring agents such as dye and pigment; an antistatic agent and a non-flammable agent. These may be utilized alone or in combination.

(2.3.1) Antioxidant

An antioxidant includes a phenol type antioxidant, a phosphoric type antioxidant and a sulfur type antioxidant. By incorporation of these antioxidants, it is possible to prevent coloring and decrease of strength of a lens due to oxidation deterioration at the time of molding of an optical resin material without decreasing transparency and thermal resistance.

As a phenol type antioxidant, those conventionally well known in the art are applicable and listed are such as 2-t-butyl-6-(3-t-butyl-2-hydroxy-5-methylbenzyl)-4-methylphenyl acrylate and 2,4-di-t-amyl-6-(1-(3,5-di-t-amyl-2-hydroxyphenyl)ethyl)phenyl acrylate which are described in JP-A 63-179953; acrylate type compounds such as octadecy-1-3-(3,5-di-t-butyl-4-hydroxyphenyl)propionate described in JP-A 1-168643; alkyl substituted phenol type compounds such as 2,2′-methylene-bis(4-methyl-6-t-butylphenol), 1,1,3-tris(2-methyl-4-hydroxy-5-t-butylphenyl)butane, 1,3,5-trimethyl-2,4,6-tis(3,5-di-t-butyl-4-hydroxybenzyl)benzene, tetrakis(methylene-3-(3′,5′-di-t-butyl-4′-hydroxyphenylpropionate))methane, that is, pentaerythrimethyl-tetrakis(3-(3,5-di-t-butyl-4-hydroxyphenyl propionte)) and triethyleneglycol bis(3-(3-t-butyl-4-hydroxy-5-methylphenyl)propionate); and triazine group containing phenol type compounds such as 6-(4-hydroxy-3,5-di-t-butylanilino)-2,4-bisoctylthio-1,3,5-triazine, 4-bisoctylthio-1,3-5-triazine, 2-octylthio-4,6-bis-(3,5-di-t-butyl-4-oxyanilino)-1,3,5-triazine.

A phosphoric type antioxidant is not specifically limited provided being those generally utilized in ordinary resin industry, and includes monophosphite type compounds such as triphenyl phosphite, diphenylisodecyl phosphite, phenyldiisodecyl phosphite, tris(nonylphenyl)phosphite, tris(dinonylphenyl)phosphite, tris(2,4-di-t-butylphenyl)phosphite and 10-(3,5-di-t-butyl-4-hydroxybenzyl)-9,10-dihydro-9-oxa-10-phosphophenanthrene-10-oxide; and diphosphite type compounds such as 4,4′-butylidene-bis(3-methyl-6-t-butylphenyl-di-tridecyl phosphite) and 4,4′-isopropylidene-bis(phenyl-di-alkyl(C12-C15) phosphite). Among them, monophosphite type compounds are preferable and such as tris(nonylphenyl)phosphite, tris(dinonylphenyl)phosphite and tris(2,4-di-t-butylphenyl)phosphite are specifically preferable.

A sulfur type antioxidant includes such as dilauryl-3,3-thiodipropionate, dimyristyl-3,3′-thiodipropionate, distearyl-3,3-thiodipropionate, laurylstearyl-3,3′-thiodipropionate, pentaerythritol-tetrakis-(β-lauryl-thiopropionate) and 3,9-bis(2-dodecylthioethyl)-2,4,8,10-tetraoxaspiro[5,5]undecane.

Further, in addition to the above-described phenol type, phosphoric type and sulfur type antioxidants, an amine type antioxidant such as diphenylamine derivatives and thiocarbamate of nickel or zinc can be applicable.

The above-described antioxidants each can be utilized alone or in combination of not less than two types. The blending amount is appropriately selected within a range of not disturbing the object of the present invention, however, is preferably in arrange of 0.001-20 weight parts and more preferably 0.01-10 weight parts, against 100 weight parts of an optical resin material.

(2.3.2) Anti-Whitening Agent

As an anti-whitening agent, a compound having the lowest glass transition temperature of not higher than 30° C. can be blended. Thereby, it is possible to restrain whitening of thin film under a high temperature and high humidity environment without deteriorating various properties such as transmittance, heat resistance and mechanical strength

(2.3.3) Light Fastness Stabilizer

Light fastness stabilizers (light stabilizers) are roughly classified into a quencher and a radical scavenger. Light fastness stabilizers of a benzophenone type, a benzotriazole type and a triazine type are classified into a quencher and a hindered amine type light fastness stabilizers are classified into a radical scavenger. In the present invention, a hindered amine light fastness stabilizer (HALS) is preferably utilized with respect to such as transparency and anti-coloring property of a lens. Such a HALS can be specifically selected from those having a low to medium molecular weight and those having a high molecular weight. For example, those having a relatively low molecular weight include L-77 (manufactured by ADEKA Corp), TINUVIN 765, TINUVIN 123, TINUVIN 440 and TINUVIN 144 (manufactured by LISA Japan Ltd.), HOSTAVIN N20 (manufactured by HOECHIST AG); those having a medium molecular weight include LA-57, LA-52, LA-67 and LA-62 (manufactured by ADEKA Corp.); and further those having a high molecular weight include LA-68 and LA 63 (manufactured by ADEKA Corp.), HOSTAVIN N30 (manufactured by HOECHIST AG), CHIMASSORB 944, CHIMASSORB 2020, CHIMASSORB 119 and TINUVIN 622 (manufactured by CIBA Japan Ltd.), CYASORB UV-3346 and CYASORB UV-3529 (manufactured by CYTEC NDUSTRIES Inc.) and UVASIL 299 (manufactured by GLC Corp.). Specifically, a HALS having a low or medium molecular weight is preferably utilized for a molded article (an optical element) containing an optical resin material and a HALS having a high molecular weight is preferably utilized for an optical resin material of a film form.

A HALS is also preferably utilized in combination with a light fastness stabilizer of a benzotriazole type. For example, listed are such as ADEKASTAB LA-32, LA-36 and LA-31 (manufactured by ADEKA Corp.), TINUVIN 326, TINUVIN 571, TINUVIN 234 and TINUVIN 130 (manufactured by CIBA Japan Ltd.).

Further, a HALS is preferably utilized in combination with a various antioxidants described above. The combination of a HALS and an antioxidant is not specifically limited, and possible is a combination with such as a phenol type, a phosphor type and a sulfur type; however, specifically preferable is a combination with a phosphor type or a phenol type.

(2.3.4) Other Additives

In addition to an antioxidant and a light fastness agent described above, listed are stabilizers such as a thermal stabilizer, a weather proofing agent, an infrared absorbent; resin modifiers such as a sliding agent and a plasticizer; anti-whitening agents such as soft polymer and an alcoholic compound; coloring agents such as dye and pigment; an antistatic agent and a non-flammable agent. These blending agents may be utilized alone or in combination of not less than two types, and the blending amount is appropriately selected in a range not to disturb the effects described in the present invention.

Further, by blending a compound having the lowest glass transition temperature of not higher than 30° C. in an optical resin material of the present invention, it is possible to restrain whitening under a high temperature and high humidity environment after use for a long period of time without deteriorating various properties such as transparency, thermal resistance and mechanical strength.

(3) Manufacturing Method of Optical Resin Material

A manufacturing method of an optical resin material of the present invention is constituted of a particle forming process to uniformly disperse one type of metal oxide, or silicon oxide with metal oxide of other than silicon, to form homogeneous oxide particles, a hydrophobic treatment process to provide a hydrophobic treatment on the surface of homogeneous oxide particles to form hydrophobic oxide particles after the particle forming process, and a kneading process to knead hydrophobic oxide particles and curable resin such as thermally curable resin after the hydrophobic treatment process.

The content of hydrophobic oxide particles against curable resin is preferably not less than 1.0% and not more than 90%, more preferably not less than 2.0% and not more than 70% and furthermore preferably not less than 3.0% and not more than 50%, based on volume %.

(3.1) Kneading Process

In a kneading process, a manufacturing method to add-knead hydrophobic oxide particles against curable resin to prepare an optical resin material, or a method to mix curable resin dissolved in a solvent and hydrophobic oxide particles followed by removing the organic solvent to prepare an optical resin material are preferable embodiments.

In a kneading process, an optical resin material is specifically preferably prepared by a kneading method. A method to polymerize curable resin in the presence of hydrophobic oxide particles, or preparation of hydrophobic oxide particles in the presence of curable resin is also possible; however, it is not preferred because special conditions may be required for polymerization of curable resin and preparation of hydrophobic oxide particles. Since a kneading method enables preparation of an optical resin material by mixing curable resin and hydrophobic oxide particles prepared in a conventional method, it is generally possible to prepare an optical resin material at low cost.

In kneading, an organic solvent can be also utilized. In this case, it is preferable to perform degassing after kneading to remove the organic solvent from an optical resin material.

An apparatus utilized for kneading includes closed type kneaders or batch type kneaders such as LABO PLUSTOMILL, BRABENDER, BUNBERY's mixer, a kneader and a roll. Further, continuous type kneaders such as a mono-axial extruder and a biaxial extruder can be also utilized for manufacturing.

In the case of utilizing a kneader as a processing embodiment of a kneading process, curable resin and hydrophobic oxide particles may be added and kneaded in one lump, or may be divisionally added stepwise and kneaded. In this case, in a kneader such as an extruder, it is also possible to add the component to be added stepwise on the way of a cylinder. In a kneading process, it is preferable to add a light fastness stabilizer in a process as late as possible, and at least a part of a light fastness stabilizer is added after addition of hydrophobic oxide particles.

In the case of compositing of curable resin and hydrophobic oxide particles by kneading, hydrophobic oxide particles can be added in a state of powder or in a coagulated state as it is. Further, hydrophobic oxide particles are also possible to be added in a state of being dispersed in a liquid. In the case of adding hydrophobic oxide particles in a state of being dispersed in a liquid, degassing is preferably performed after kneading.

In the case of adding hydrophobic oxide particles into a liquid in a state of being dispersed, it is preferable to add coagulated particles by being dispersed to be primary particles in advance. For dispersion, various types of homogenizers can be utilized; however, a beads mill is specifically preferred. Beads may contain of various materials; however, the diameter is preferably small and specifically preferably 0.001-0.1 mm based on a diameter.

Homogeneous oxide particles are preferably added by having been subjected to a hydrophobic treatment (having been made to be hydrophobic oxide particles); however, employed may be a procedure such as integral blending in which the above-described surface processing agent and homogeneous oxide particles are simultaneously added and compositing of thermally curable resin and homogeneous oxide particles is performed, or any other procedures can be employed.

(4) Examples of Manufacturing Method and Application of Optical Element

(4.1) Molding of Optical Resin Material

After preparation of curable resin and hydrophobic oxide particles in the above-described manner, an optical resin material can be molded into a predetermined form by curing the thermally curable resin with heat in the case of curable resin being thermally curable resin, whereby an optical element can be prepared. Specifically, an optical resin material may be curing molded by means of such as compression molding, transfer molding and ejection molding. Specifically, to utilize thermally curable resin as a starting material of a molded article is preferred in the case of manufacturing an optical element (for example, an objective lens) the optical surface of which provides a spherical or non-spherical form and having a fine structure.

Molded articles can be utilized in various forms such as a spherical form, a bar form, a plate form, a column form, a pipe form, a tube form, a fiber form and a film or sheet form, and are excellent in low double refractive index property, transparency, mechanical strength, thermal resistance and low water absorption to be preferably utilized as various optical parts such as described below.

Herein, the items related to “molding” will be further explained.

In the case of an optical element employing a thermoplastic resin, molding is performed generally by means of ejection molding. An ejection molder utilized at this time is constituted of a part to melt stating material resin by rotating a screw in a heated cylinder and to eject through a nozzle arranged on the top of the cylinder, and a clamping part to hold a molding die which receives melted resin having been ejected.

Starting material resin is drawn into a cylinder from a hopper arranged at the base of the cylinder by rotation of a screw and kneaded with the screw while being melted with heating from the cylinder. The screw goes back while rotating to reserve a certain amount of resin in the front portion of the cylinder. By ejecting the screw forward with high pressure when a certain amount of melted resin is reserved, melted resin is ejected through a nozzle into a molding die. Since a strong inner pressure is applied in a molding die at this time, the molding die is kept damped with a strong pressure not to be opened. This pressure to clamp is referred as clamping pressure.

On the other hand, when melt viscosity of resin is the smaller, the ejection pressure can be made small. That the melt viscosity is small means that the melt index (MI) is large, that is, small is the mean molecular weight. That the molecular weight is small means that mechanical properties such as strength are lowered. Therefore, when the strength of a molded article is intended to be increased, it is necessary to utilize those having a large mean molecular weight, that is, those of lower grade having a low MI and poor fluidity. As a result, an ejection molder having higher clamping pressure is required. Therefore, a steel material utilized for a die is necessarily to have high hardness and high strength, which requires an expensive cost of a die.

Concerning this, as a part of methods for molding thermally curable resin, there is a procedure called Reaction Injection Molding (RIM). Said procedure is a method in which such as filler in addition to a monomer to be a starting material and a catalyst are mixed immediately before being injected into a molding die and to inject them into a molding die at a dash to be heated, whereby a polymerization reaction is induced in a molding die to prepare a molded article (a plastic product). Since said procedure is low pressure molding and general steel materials such as general carbon steel, aluminum or Ni shell are applicable, the cost of a molding die is cheep.

According to the above-described manufacturing method of an optical element, since inorganic micro-particles having a certain mean particle diameter are added against thermally curable resin, the volume of thermally curable resin is decreased by an amount corresponding to the addition amount resulting in shortening of the curing time of an optical resin material at the time of molding.

(4.2) Application Examples

An optical element of the present invention is prepared according to the above-described manufacturing method and can be applied for optical parts such as described below.

For example, as an optical lens and an optical prism, listed are a camera picture taking lens; lenses of such as a microscope, an endoscope and a telescope; a total light transmitting lens such as a glasses lens; pickup lenses of an optical discs such as CD, CD-ROM, WORM (a write once optical disc), MO (a rewritable optical disc; a magneto optical disc), MD (a mini disc) and DVD (a digital video disc); laser scanning lenses such as a fθ lens and a sensor lens of a laser printer, and a prism lens of a finder system of a camera.

As for optical disc applications, listed are CD, CD-ROM, WORM (a write once optical disc), MO (a rewritable optical disc, a magneto optical disc), MD (a mini disc) and DVD (a digital video disc). As other optical applications, listed are a polarizer of such as a liquid crystal display optical film such as polarizing film, phase difference film and light diffusion film; a light diffusion plate; an optical card; and a liquid crystal display element substrate.

### EXAMPLES

### [1] Preparation of Samples

(1.1) Preparation of Optical Resin Material 1

SILICA AEROSIL 200 manufactured by NIPPON AEROSIL Co., Ltd. having a mean particle diameter of 12 nm was heated under the atmosphere at 200° C. for one hour. Into 30 g of the powder obtained by heating as above, tetramethyldisilazne of 12 g was added while stirring the powder under dry nitrogen. Thereafter, the powder added with tetramethyldisilazane was heated at 200° C. for 30 minutes, followed by being cooled to room temperature (a hydrophobic treatment process). As a result, silica “hydrophobic oxide particles 1” which had been subjected to a hydrophobic treatment was prepared.

As a result of TEM observation, the volume average particle diameter of hydrophobic oxide particles 1 was found to be 12 nm. Thereafter, this hydrophobic oxide particles 1 and thermally curable resin (a methacrylate resin) were melt-kneaded while being degassed to prepare “optical resin material 1” (a kneading process).

The content (the filling ratio) of hydrophobic oxide particles 1 in optical resin material 1 was set to 25 volume % based on the volume of the thermally curable resin. In a kneading process of the melt-kneading, LABO PLUSTMILL KF-6V was utilized to perform kneading at 100 rpm for 10 minutes under nitrogen and, for 2 minutes before finishing said kneading, degassing at 20 Torr (2,666 Pa) was performed.

(1.2) Preparation of Optical Resin Material 2

Tetramethyldisilazane of 30 g was added into a mixed solution containing 2,700 g of ethanol and 300 g of water and the solution was mixed. The resulting solution was added with 15 g of acetic acid followed by being stirred for not less than 10 minutes. This mixed solution was added with 50 g of SILICA AEROSIL 200 manufactured by NIPPON AEROSIL Co., Ltd. having a mean particle diameter of 12 nm to be stirred for 1 hour at room temperature, and then ethanol and water were refluxing stirred at 100° C. for 1 hour. The resulting solution was subjected to a centrifugal separation treatment at 8,000 rpm for 30 minutes, whereby particles precipitated were recovered. The recovered particles were further washed with 1,000 g of ethanol to remove acetic acid and non-reacted tetramethyldisilazane and again subjected to a centrifugal separation treatment at 8,000 rpm for 30 minutes, whereby particles precipitated were recovered. This operation was repeated three times to wash out acetic acid and non-reacted tetramethyldisilazane and the recovered particles were dried in an oven at 150° C. for 2 hours, followed by being cooled down to mom temperature (a hydrophobic treatment process). As a result, “hydrophobic oxide particles 2” having been subjected to a hydrophobic treatment was prepared.

As a result of TEM observation, the volume average particle diameter of hydrophobic oxide particles 2 was 12 nm. Thereafter, this hydrophobic oxide particles 2 and thermally curable resin (methacrylate type resin) were melting kneaded while being degassed to prepare “optical resin material 2” (a kneading process).

The content (the filling ratio) of hydrophobic oxide particles 2 in optical resin material 2 was set to 20 volume % based on the volume of the thermally curable resin. In a kneading process of melt kneading, LABO PLUSTMILL KF-6V was utilized to perform kneading at 100 rpm for 10 minutes under nitrogen and, for 2 minutes before finishing said kneading, degassing at 20 Torr was performed.

(1.3) Preparation of Resin Material 3

“Optical resin material 3” was prepared in the same manner as described for optical resin material 2 except that tetramethyldisilzane was replaced with pyridine.

(1.4) Preparation of Resin Material 4

“Optical resin material 4” was prepared in the same manner as described for optical resin material 2 except that tetramethyldisilzane was replaced with vinyltrimethoxysilane.

(1.5) Preparation of Resin Material 5

“Optical resin material 5” was prepared in the same manner as described for optical resin material 2 except that tetramethyldisilzane was replaced by vinyltrichlorosilane.

(1.6) Preparation of Resin Material 6

“Optical resin material 6” was prepared in the same manner as described for optical resin material 2 except that SILICA AEROSIL 200 manufactured by NIPPON AEROSIL Co., Ltd having a mean particle diameter of 12 nm were directly melt-kneaded while degassing thermally curable resin (methacrylate type resin) without performing a hydrophobic treatment process.

(1.7) Preparation of Samples 1-6

Optical resin materials 1-6 prepared above were pressed at 120° C. under vacuum of 10 Torr (1,333 Pa) to prepare molded articles of Φ 11 mm and 3 mm thick which were designated as “samples 1-6”. Two sheets were prepared for each of the samples for preparation of a sample subjected to a post-curing process and a sample without the post-curing processing. Herein, each of the samples 1-6 was subjected to surface grinding.

(1.8) Post-Curing Process

One of the two samples of each of samples 1-6 was annealed (heated in a dry thermostatic oven at 190° C. for 1 hour) and then each sample after having been annealed was designated as 1A-6A, respectively.

### (2) Measurement of Physical Properties of Each of the Samples 1-6 and Annealed Samples 1A-6A

As for the absorbance intensity of an infrared absorption spectrum, the measurement was carried out with respect to an optical composite resin material by use of Fourier Conversion Infrared Spectrometer NICOLET 380.

A: absorbance intensity at 1720 cm⁻¹

B: absorbance intensity at 1637 cm⁻¹

The value of B/A will be described in table 1.

### (3) Evaluation of Samples

(3.1) Measurement of Coefficient of Linear Expansion

Each of the samples 1-6 and 1A-6A was subjected to a temperature variation in a range of 40-60° C., whereby a coefficient of linear expansion with respect to each sample was measured. As a measurement apparatus, EXSTAR 6000 TMA/SS6100 manufactured by SII (SEIKO INSTRUMENTS Co., Ltd.) was utilized. The results of the measurements will be shown in following table 1.

(3.3) Measurement of Light Transmittance

With respect to each of the samples 1-6 and 1A-6A, the total transmitting light quantity against the incident light quantity of visible light was measured according to ASTM D-1003. The measurement results will be shown in table 1.

(3.4) Measurement of Water Absorption Coefficient

By use of an oven with a high temperature and high humidity conditioning (PR-2PK, manufactured by ESPEC Co., Ltd), each of the samples 1-6 and 1A-6A was dried at 100° C., 10% RH for 100 hours in advance, followed by being stored at 60° C., 90% RH for 500 hours to be humidified. From the weight increase portion of each of the samples 1-6 and 1A 6A after humidification against the weight of each sample, the water absorption coefficient of each sample was calculated. The calculated results will be shown in following table 1.

TABLE 1

| | | Sample content | | | | | | | | |
|---|---|---|---|---|---|---|---|---|---|---|
| | | Reactive | | | | | | | | |
| | | group of | | | | Infrared | Coefficient | | | |
| | | surface | Hydro- | Particle | | absorption | of linear | Light | Water | |
| Sample | | treatment | phobic | diameter | Post- | spectrum | expansion | transmittance | absorption | |
| No. | Surface treatment agent | agent | treatment | (nm) | curing | B/A | (ppm) | (%) | rate (%) | Remarks |
| 1 | Teteramethylenedisilazane | Absent | Present | 12 | Absent | 0.45 | 120 | 80 | 1 | Comparative |
| 2 | Teteramethylenedisilazane | Absent | Present | 45 | Absent | 0.5 | 110 | 78 | 1.1 | Comparative |
| 3 | Pyridine | Absent | Present | 56 | Absent | 0.25 | 80 | 54 | 0.3 | Comparative |
| 4 | Vinyltrimethoxysilane | Present | Present | 13 | Absent | 0.25 | 60 | 90 | 0.5 | Inventive |
| 5 | Vinyltrichlorosilane | Present | Present | 13 | Absent | 0.2 | 65 | 89 | 0.3 | Inventive |
| 6 | None | Absent | Absent | 12 | Absent | 0.5 | 120 | 60 | 1.5 | Comparative |
| 1A | Teteramethylenedisilazane | Absent | Present | 12 | Present | 0.04 | 50 | 85 | 0.3 | Inventive |
| 2A | Teteramethylenedisilazane | Absent | Present | 45 | Present | 0.1 | 55 | 87 | 0.2 | Inventive |
| 3A | Pyridine | Absent | Present | 56 | Present | 0.2 | 80 | 50 | 0.2 | Comparative |
| 4A | Vinyltrimethoxysilane | Present | Present | 13 | Present | 0.04 | 50 | 90 | 0.2 | Inventive |
| 5A | Vinyltrichlorosilane | Present | Present | 13 | Present | 0.03 | 45 | 89 | 0.2 | Inventive |
| 6A | None | Absent | Absent | 12 | Present | 0.1 | 100 | 85 | 1.2 | Inventive |

As shown in table 1, it is clear that with respect to samples 1-6 and 1A-6A, samples of the present invention exhibit high transparency, a low linear expansion and a low water absorption coefficient compared to those of the comparative samples.

1. An optical resin material comprising a curable resin and hydrophobic oxide particles,
wherein
an absorbance intensity ratio B/A is 0.01 to 0.25, provided that A represents an absorbance intensity at 1720 cm⁻¹ of an infrared absorption spectrum of the optical resin material after cured, and B represents an absorbance intensity at 1637 cm⁻¹ of the infrared absorption spectrum of the optical resin material after cured; and
a volume average particle diameter of the hydrophobic oxide particles is 1.0 nm to 50 nm.

2. The optical resin material of claim 1, wherein the curable resin is a thermally curable resin.

3. The optical resin material of claim 1, wherein the curable resin comprises an acryl monomer.

4. The optical resin material of claim 1, wherein surfaces of the hydrophobic oxide particles are subjected to a hydrophobic treatment with a silazane.

5. The optical resin material of claim 1, wherein surfaces of the hydrophobic oxide particles are subjected to a hydrophobic treatment with a silane coupling agent having a reactive group.

6. The optical resin material of claim 1, wherein surfaces of the hydrophobic oxide particles are subjected to a hydrophobic treatment with a chlorosilane.

7. An optical element molded by employing the optical resin material of claim 1.
